(19) United States
(12) Patent Application Publication
(10) Pub. No.: US 2022/0069577 A1
(43) Pub. Date: Mar. 3, 2022

(54) Systems, Methods and Apparatus for Critical Event Monitoring, Capture, and Response Near Overhead Electrical Power Lines and Associated Equipment and Facilities

(71) Applicant: Delphire Inc., PASADENA, CA (US)

(72) Inventors: Gilberto DeSalvo, Pasadena, CA (US); Matthew D. Smalley, Newhall, CA (US)

(21) Appl. No.: 17/446,696

(22) Filed: Sep. 1, 2021

Related U.S. Application Data
(60) Provisional application No. 63/073,144, filed on Sep. 1, 2020.

(51) Int. Cl. H02J 3/00; G01W 1/10

(52) U.S. Cl. CPC H02J 3/0073; G01W 1/10; H02J 3/0012

(57) ABSTRACT

Electrical transmission lines (e.g. overhead lines), associated equipment, and proximal environment monitoring by data acquisition units (DAUs) that provide information that (1) can directly indicate a critical event occurrence or that can trigger operator review, (2) can be processed alone or in combination to ascertain the occurrence of such an event or that can trigger operator review, and/or (3) can be processed by trained AI software to provide an event inference. In some embodiments, enhanced risk of event occurrence can be ascertained to provide modified system behavior and/or to provide a proactive advanced mitigation response. Events of interest include, for example: fire, powerline obstruction or interference, physical line failure, excessive line movement, excessive ground movement, excessive arcing, and the like.

### PRIORITY CLAIMS AND CROSS-REFERENCE TO RELATED APPLICATIONS

This application is related to and claims domestic priority benefits under 35 USC § 119(e) from U.S. Provisional Patent Application Ser. No. 63/073,144 filed on Sep. 1, 2020, the entire contents, of the aforementioned application, are expressly incorporated hereinto by reference.

### GOVERNMENT GRANTS

This Invention was made with U.S. Government support under Contract No. DE-SC0021807 awarded by the Department of Energy. The Government has certain rights in this invention.

### FIELD OF THE INVENTION

This invention relates to the field of electrical power transmission (between power plants and end users), more particularly in some embodiments, to power transmission by overhead power lines, and even more particularly to the field of monitoring physical events occurring around overhead powerlines and related equipment for providing enhancements in one or more of (1) operational safety, (2) risk assessment, (3) failure prediction, (4) failure recognition, (5) proactive maintenance, (6) critical event capture, (7) event reporting, and (8) emergency response, (e.g. related to wildfires, flooding, storm induced damage, earthquakes, other natural or man initiated events, system component failure, and/or enhanced risk of system failure).

### BACKGROUND

Electrical power in the United States provides about 50% of commercial power, about 40% of residential power, and about 10% of industrial power. Large powerplant generation still represents the vast majority of the electricity production in the United States. For usage, this vast amount of energy must be effectively transferred from generation locations to use locations. In the United States, over 200,000 miles of high voltage transmission lines (230K volts or greater) exist along with over 5.5 million miles of local distribution lines. A small percentage of these transmission lines are underground with the vast majority being overhead. In the state of California, more than 25,000 miles of high voltage transmission lines exist with over 200,000 miles of distribution lines with over two-thirds being overhead. Underground lines typically require two or more splicing vaults or above ground structures per mile along with transition stations whenever connections between above ground and below ground transmission lines occur.

Below ground transmission lines offer significant advantages in some ways (e.g. reduced risk of damage from fires, storms, or ice; reduced risk of causing fires; and better aesthetics) while having significant disadvantage in other respects (e.g. high installation costs; shorter life; higher repair costs; and more difficulty in ascertaining exact failure locations; and longer and higher repair times and costs).

Though some transmission line monitoring is in use or has been proposed, a need still remains for more effective methods and systems for monitoring of overhead transmission lines and associated equipment.

### SUMMARY

In accordance with an aspect of the present disclosures, there is provided a system, including an anomaly detection system, comprising, at least one data acquisition unit communicatively coupled to at least one monitoring station wherein the data acquisition unit is affixed unto a powerline structure and/or an ancillary pole; the data acquisition unit incorporates at least one transducer, used to measure environmental conditions and/or characteristics of the surrounding area; and the data acquired by the data acquisition unit relays the data from the transducer to the at least one monitoring station for identification of an anomaly.

Moreover, according with an aspect of the present disclosures, the anomaly detection system has at least one transducer, incorporating one or more of the following types of sensors: wind speed sensor, wind direction sensor, air temperature sensor, gravity sensor, accelerometer, rotational motion sensor, barometric pressure sensor, humidity level sensor, surface temperature sensor, compass sensor, Global Positioning System sensor, orientation and/or elevation sensor, conductivity sensor, resistivity and current flow sensors, torsional sensor, image sensor, light sensor, ultraviolet light sensor, infrared light sensor, radio wave sensor, spectral wavelength sensor, sound sensor, optical sensor, vibration and electromagnetic sensors.

In addition, the anomaly detection system has the at least one monitoring station which analyzes the data supplied by the at least one data acquisition unit using prior datasets by comparison or through an artificial intelligence algorithm to identify an anomaly such as: fire risk, obstruction, physical failure, abnormal temperature, abnormal movement, line stress or sagging, excessive throughout, abnormal vibrations, abnormal moisture or abnormal humidity.

Further still, the anomaly detection system has a relay unit communicatively coupled to a primary data acquisition unit and at least one or more secondary data acquisition units.

Moreover, the anomaly detection system has one or more storage device(s) communicatively coupled to the at least one monitoring station or the at least one data acquisition unit.

In addition, the anomaly detection system analysis of the data can trigger an alert and/or be further used to retrain the artificial intelligence algorithm.

Further still, the anomaly detection system of has one or more data acquisition support units communicatively coupled to the at least one data acquisition units.

Moreover, the anomaly detection system has the at least one data acquisition unit has at least two optical or imaging sensors oriented to monitor different perspectives of the powerline structure, its components and/or a transmission wires located on the powerline or on its components; and the at least two optical or imaging sensors have three degrees of freedom.

In addition, the anomaly detection system has the at least one data acquisition unit and the at least one monitoring station are communicatively coupled together over a mesh network topology such that data transmission between these components are minimized following the analysis conducted using the artificial intelligence algorithm.

Finally, the anomaly detection system can share data amongst any of the at least one data acquisition units or any of the at least one monitoring stations.

### DESCRIPTION OF THE DRAWINGS

Embodiments in accordance with the present disclosure are shown in the drawings and will be described below with reference to the figures, whereby elements having the same effect have been provided with the same reference numerals. The following is shown:

FIG. 1 provides a block diagram of a first embodiment of the present disclosure.

FIG. 2 provides a block diagram of a second embodiment of the present disclosure.

FIG. 3 provides a block diagram of a third embodiment of the present disclosure.

FIG. 4 provides a block diagram of a fourth embodiment of the present disclosure.

FIG. 5 provides a block diagram of a fifth embodiment of the present disclosure.

FIG. 6 provides a block diagram of a sixth embodiment of the present disclosure.

FIG. 7 provides a block diagram of a seventh embodiment of the present disclosure.

FIG. 8 provides a block diagram of an eighth embodiment of the present disclosure.

FIG. 9 provides a block diagram of a ninth embodiment of the present disclosure.

FIG. 10 provides a block diagram of a tenth embodiment of the present disclosure.

FIG. 11 provides a block diagram of an eleventh embodiment of the present disclosure.

FIG. 12A provides a block diagram listing example subsystems of the present disclosure herein.

FIG. 12B provides a block diagram listing example power sources of the present disclosure herein.

FIG. 12C provides a block diagram listing example sensors or transducers that can be used in the present disclosure herein.

FIG. 12D provides a block diagram listing example control and electronic communication components of the present disclosure herein.

FIG. 12E provides a block diagram listing example functions for the control and communication electronic subsystem of the present disclosure herein.

FIG. 12F provides an example of components and functions of the Data Acquisition Support Unit (DASU) of the present disclosure herein.

FIG. 12G provides an example of components and functions that may be included in a Relay Unit (RU) of the present disclosure herein.

FIG. 12H depicts a configuration of some of the embodiments of the present disclosure herein.

FIG. 13A provides a block diagram setting for various sample components that may be included in a monitoring station or a storage device.

FIG. 13B provides a block diagram setting for various sample functions that may be performed at a monitoring station or on a storage device.

FIG. 14 provides an overview of a communication structure according to an embodiment of the present disclosure herein.

FIG. 15 provides a schematic representation of a Data Acquisition Unit (DAU) according to an embodiment of the present disclosure herein.

FIG. 16 provides a schematic representation of a DAU according to another embodiment of the present disclosure herein.

FIG. 17 provides a sample process flow of communication of an embodiment of the present disclosure herein.

FIG. 18 provides a sample process flowchart of anomaly detection and alerting based on an embodiment of present disclosure herein.

### DESCRIPTION

Embodiments of the present disclosure provide systems/methods that use autonomous and/or controllable data gathering units that have been placed in proximity to, or on transmission structures, and particularly above ground and overhead structures (e.g. lines, towers, poles) as well as around related structures (e.g. sub-stations, above ground splicing stations for underground transmission lines, transition stations where overhead and underground transmission line connect).

These data gathering or Data Acquisition Units (DAUs) have sensors and imaging devices that provide data that may be useful in detecting or inferring occurrence of an event of interest (e.g. one or more of a fire, an obstruction on or otherwise impacting a power line, excess powerline movement, powerline breakage or collapse, excess arcing, excess ground movement and the like). A DAU or a plurality of DAUs are in communication with at least one Monitoring Station (MS) and possibly with one or more data storage devices, over one or more network connections which may include back up networks in an event of primary network failure. The MS(s) may be configured to present raw data to an operator in text, graphical, image form, augmented reality formats, and/or a combination of these. The MS(s) may be configured to present data alerts, warnings, or critical data in an enhanced manner that may include visual components, audio prompts, tactile prompts, signaling to secondary MS(s), or to other electronic devices.

In addition to, or as an alternative to, inference done by a DAU or group of DAUs, the MS may process the data received de novo or may process the data in a manner based on any inference already provided from the DAU which may involve correlating additional data from additional DAUs and other sources/non-system resources. The processing performed by MS(s) may be limited to formatting for presentation, or temporal or spatial correlations of data from one or more DAUs, DASUs (discussed later), and/or Relay Units (Rus)—discussed late.

The processing may involve system initiated or operator initiated preprogrammed routines to provide conclusions directly from the data. For example, the data may indicate that multiple locations are showing spatially spread heat signatures above a predefined event value (e.g. above 500° F., 1000° F., or even 2000° F.) which are expanding or moving with time—a “possible fire” conclusion, a “probable fire” conclusion, or a “fire” conclusion may be created which may initiate additional alerts or data or view processing (e.g. switch to a live visual or Infrared (IR) camera mode).

The system itself or an operator may initiate a trained Artificial Intelligence (AI) routine to provide an inference about an event or a possible event. The system may routinely store gathered data and inferences. The system upon data thresholds being met, data processing yielding preliminary or final conclusions, or AI processing providing event positive inferences, the system, or individual DAUs, may self-initiate enhanced monitoring, data capture routines and/or data retention flagging. Alternatively, such enhanced monitoring, data capture routines, and/or data retention flagging may be initiated by input from an operator.

In some alternative embodiments, the system may create alerts, implement enhanced monitoring, and/or implement enhanced data capture, not as a result of an event occurrence but as a result of sensor data, processed sensor data, or inferences (e.g. AI based) providing an indication of enhanced risk or imminent anticipation of an event occurrence.

For example, a conclusion of enhanced fire risk and associated system operational modifications, may be implemented, as a result of sensor data or data processing is indicating on one or more of (1) local humidity around a DAU is low, local humidity is trending lower, and/or according to weather reports atmospheric conditions are predicting a general further decrease in humidity, (2) local temperature around a DAU is high (e.g. above 90° F., above 100° F., or even above 110° F.), local temperature is trending higher, and/or according to weather reports, temperature is predicted to continue climbing, (3) local wind around a DAU has a speed greater than a threshold level, e.g. for a given humidity and/or temperature, the speed is trending higher, and/or general weather forecast predicts an increase in wind speed, (4) local fuel around a DAU has moisture content below a threshold level, and/or (5) lightning has been detected in the area by one or more DAUs, (6) ozone has been detected in the area by one or more DAUs, and/or (7) the general weather forecast for the area is predicting lightning. Upon a reduction in the factors resulting in an enhanced risk conclusion, or a time lapse after such a change, system operational modifications may be reset.

In some embodiments, the removal of an enhanced risk operational state may occur using the same set points that trigger the enhanced risk conclusion in the first place while in others, there may be a need for reduction in one or more indicators below initiation thresholds for removal to occur.

In some embodiments, the data will be processed through a trained AI algorithm or engine (e.g. a neural network) to provide inferences ascertained from the data. The network will be trained to recognize certain situations. Training may involve for example feeding images of fires, images of sagging power lines, broken power lines, trees, hazards, and the like. The information will be processed through a variety of parameter variations until the resulting inferences accurately align with the real-world conditions for “unknown” data inputs. The AI algorithm parameters would also be developed from a set of control “normal” conditions (e.g. no fire, no sag, etc.). AI software training may be implemented on each of visual, Ultra Violet (UV), Infrared (IR) cameras independently or in combinations thereof as well as on non-visual data inputs independently or in combination. With the inferences concerning “unknown” data being provided.

Thus, the AI is trained to detect one, or a plurality of “detection conditions” so that it automatically recognizes it, just as a human observer would, and can provide an indication (with associated urgency level) back to the MS indicating one or more of a positive (event detection), a negative (no event detection), and/or an indeterminate state based on the level of confidence in the inference along with a description of the condition detected and/or the data supporting the inference.

The AI algorithm may be trained on a DAU, at the MS, on the storage device, or on other system units or devices (for use on data from specific DAUs, groups of DAUs, or all DAUs). Once trained, the algorithm may be loaded on to DAUs, MS(s), storage units, or other system components, for processing unknown inputs. Though preferred to run a single AI trained algorithm under all relevant circumstance, AI trained algorithm that is being executed may be different for different DAU configurations, different locations, different times of year, different times of day, different weather conditions or the like if necessary to provide inferences with a desired minimum level of accuracy based on the amount of training that is implemented

The methods and systems of various embodiments of the present disclosure may be applied to various types of overhead transmission lines including: (1) Low voltage (LV) lines operating with voltages <1 KV (e.g. to residential and commercial customers), (2) Medium voltage (MV) lines operating with voltages <69 KV, (3) High voltage (HV) lines operating with voltages up to 345 KV, (4) Extra high voltage (EHV) lines operating with voltages <800 KV, and (5) Ultra high voltage (UHV) lines operating with voltages >800 KV. System usage may occur whether the transmission lines are carrying AC or DC currents with any appropriate changes made to coupled power supply or charging systems.

Such improved monitoring may be applied to overhead power lines that are supported by different structures including simple wood poles with or without arms, tubular steel poles, lattice-type steel towers, aluminum towers, concrete poles, and reinforced plastic poles. In some implementations, DAU(s), Ru(s), or data support units may attach to support structures, may be made to be movable on support structures, may be attached to transmission wires, or be made movable on transmission wires, attached to ground wires (e.g. running from tower top to tower top) or may be made movable on such ground wires. In still other implementations, other mounting locations and/or structures may be used such as on guy wires, other purposed manmade structures near transmission lines (e.g. communication towers, buildings, beacon towers, or the like), natural formations near transmission lines (e.g. hills, ridges, trees, and the like).

Various embodiments may use one or more communication systems and carriers for communication signals. Redundant or back up networking methods and protocols may be implemented for handling data in event of primary network failure. In some back up situations, data transmission may be reduced with use with only criterial warning or data can be altered that is periodically repeated in absences of a successful communication received response. In some situations, sent data may use a different network or protocol than received data. In some embodiments, certain or all data may be encrypted or otherwise secured. It is anticipated that data will be sent digitally with sender and receiver addresses along with location and time information if not already known. Networks may range from any appropriate medium such as: wired, fiber optic, wireless terrestrial and/or satellite-based system (radio wave, microwave, other RF, IR optical, visible optical, or UV optical) that provide required range and data transfer rates. Links may be wired, guided, or free space. Wired links may use existing power transmission wires as signal carriers. Network configuration may utilize any appropriate connection point configuration and protocol such as, for example, an ad hoc network, star network, a mesh network, a fully connected network, a tree network, or an overlay network.

It is anticipated that monitoring, detection, data capture, prediction, recognition, and/or deployment as proposed herein can lead to significant enhancement in electrical power transmission safety, grid management, reduced property damage, less environmental damage, and/or more reliable service.

It is further contemplated that advantages can be drawn from each of: (1) operator based data analysis based on data from one or more MS(s) and potentially other sources, (2) at least partially automating a system based analysis of detected data, correlation of different types of detected data, and/or correlation of similar types of data from multiple separated DAU(s), and/or from non-system data sources (e.g. the weather service, news services, emergency services reports), and/or (3) inferences provided by trained AI implemented data processing (e.g. to provide support for system operator decisions and/or to provide autonomous system response decisions and actions, and/or direct instructions to maintenance crews and/or emergency crews, and/or providing direct power grid power transmission changes, power down commands as well as readiness inferences for powering up).

It is also believed that data capture as provided by the methods and systems herein may provide useful site-by-site AI training data as well as records for use in determining whether or not transmission line equipment initiated an event, contributed to the initiation of an event (e.g. a fire) or was witness and potential causality of such an event.

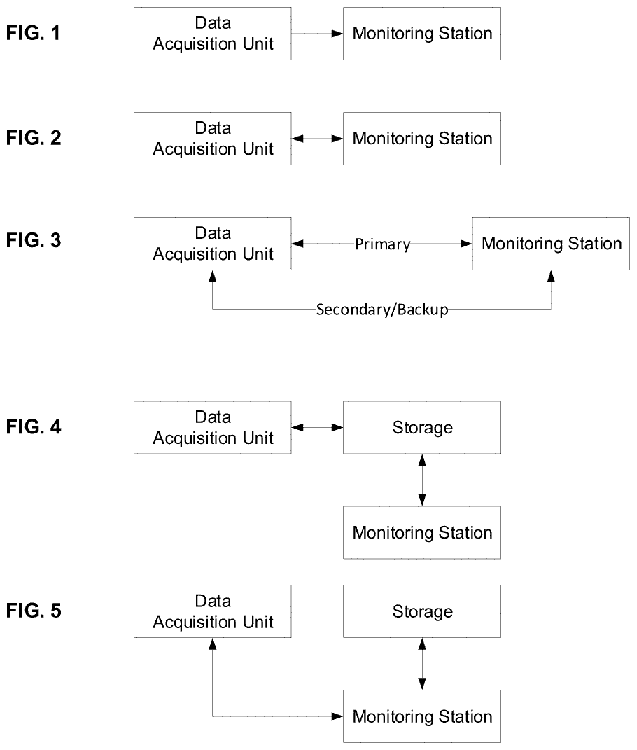

FIG. 1 provides a block diagram of a first embodiment of the present disclosure where a DAU is paired with a MS with one-way, open looped communication being provided from the DAU to the MS.

FIG. 2 provides a block diagram of a second embodiment of the present disclosure where a DAU is paired with a MS with two-way communication being provided from the DAU to the MS which allows not only the MS to receive information but also the DAU to receive commands, updates, and other useful information from the MS while also allowing both devices to receive and send message conformations.

FIG. 3 provides a block diagram of a third embodiment of the present disclosure where a DAU is paired with a MS with two-way communication via a primary network and a secondary or backup network that is automatically accessed when communications on the primary network fails.

FIG. 4 provides a block diagram of a fourth embodiment of the present disclosure where in addition to the DAU and the MS, the network incorporates an immediate Storage Device (SD) that acts as an intermediary between the DAU and the MS and provides storage of information from the DAU and potentially, communications, between the DAU and the MS as well as information obtained by processing the data.

FIG. 5 provides a block diagram of a fifth embodiment of the present disclosure where in addition to the DAU and the MS, the network incorporates a SD that is connected to the DAU via the MS and provides for storage of information received from the DAU and potentially, communications, between the DAU and the MS as well as information obtained by processing the data.

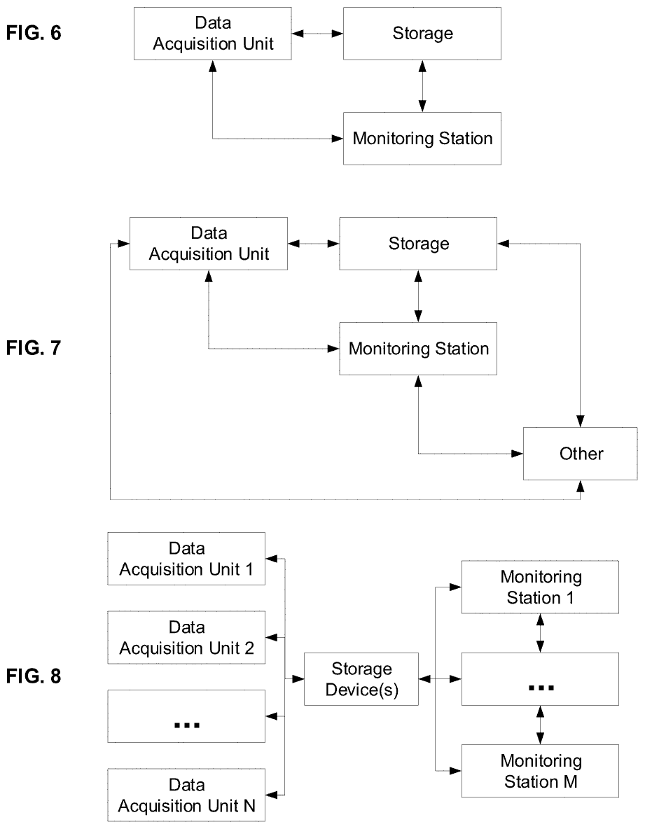

FIG. 6 provides a block diagram of a sixth embodiment of the present disclosure where the DAU, the MS, and the SD can communicate directly with one another.

FIG. 7 provides a block diagram of a seventh embodiment of the present disclosure where the DAU, the MS, and the SD not only can communicate directly with one another, but each can also communicate with another device or system which is designated as “other”.

FIG. 8 provides a block diagram of an eighth embodiment of the present disclosure that provides for one or more DAUs (from 1 to N, where N>=1, e.g. >10, >50, >200), one or more MSs (from 1 to M where, M is >=1, e.g. >2, >4, >8) and where the DAUs communicate with one or more SD(s) and the MS(s) communicate with DAU(s) through the SD(s).

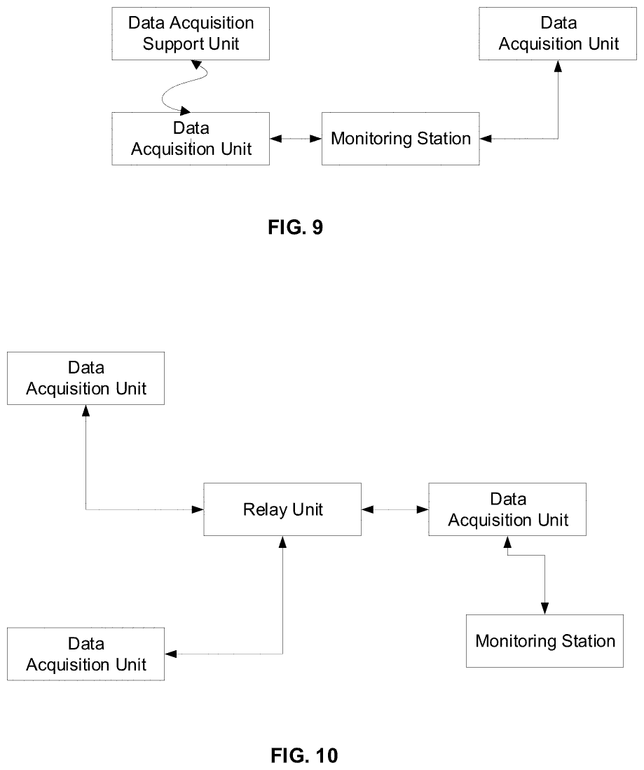

FIG. 9 provides a block diagram of a ninth embodiment of the present disclosure that includes two DAUs, a MS and a DASU which is functionally coupled with one of the DAUs to which it may be physically attached, fixedly separated but physically tethered, fixedly separated but not with a physical tether but with a dedicated communication link, moveably connected and physically tethered, or moveably connected but not with a physical tether but with a dedicated communication link.

FIG. 10 provides a block diagram of a tenth embodiment of the present disclosure with three DAUs, a MS and a RU wherein one DAU provides a communication link to the MS while the other two DAUs are in communication with the first DAU and possibly with each other via the RU which may provide only a communication functionality or may also provide additional functionalities to the system.

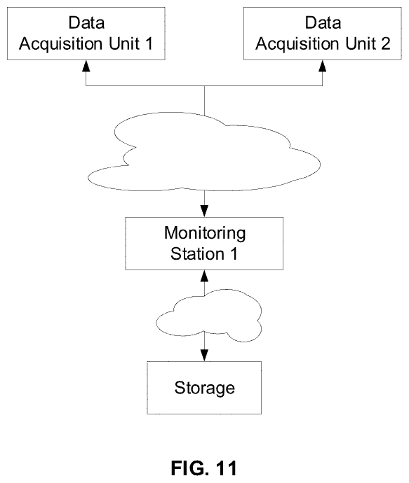

FIG. 11 provides a block diagram of an eleventh embodiment of the disclosure that includes multiple DAUs in communication with a MS over the internet and with MS connected to a SD also over the internet.

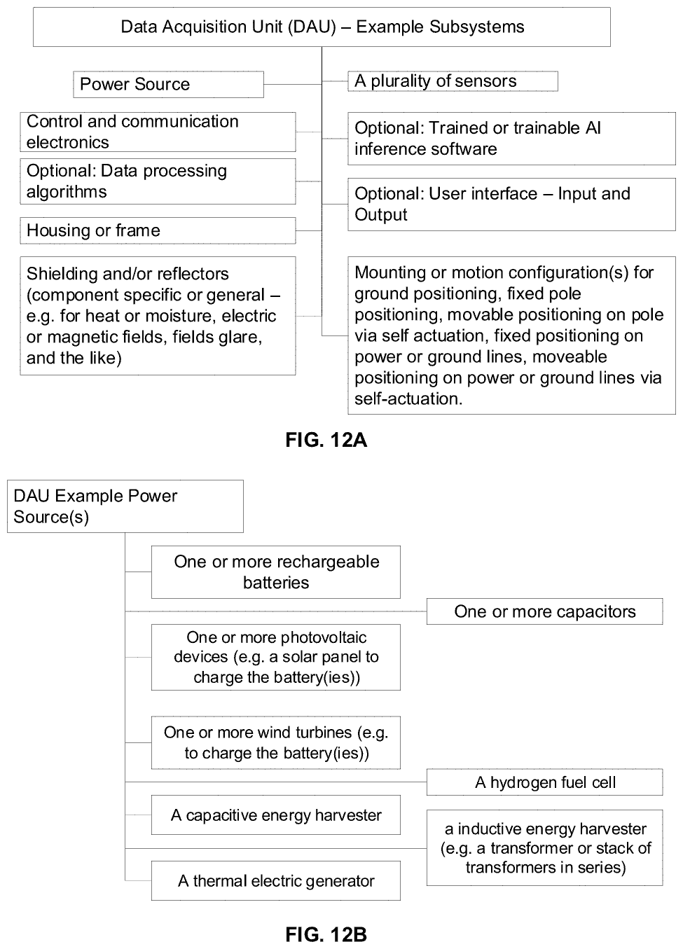

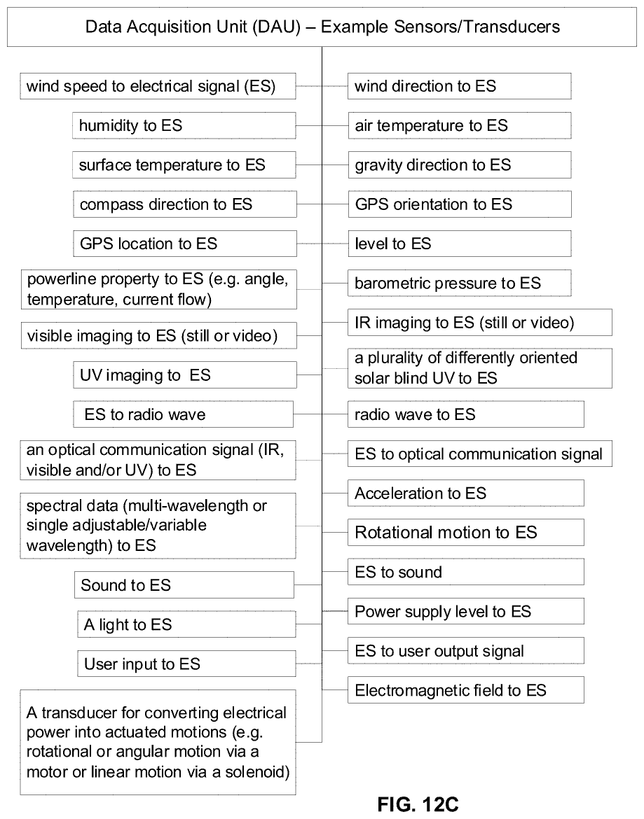

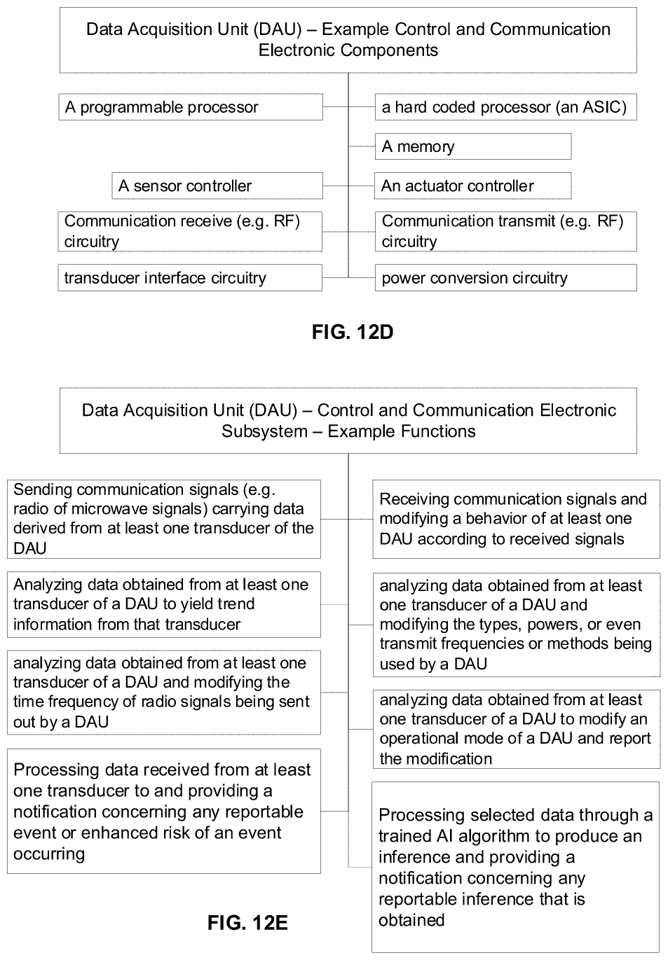

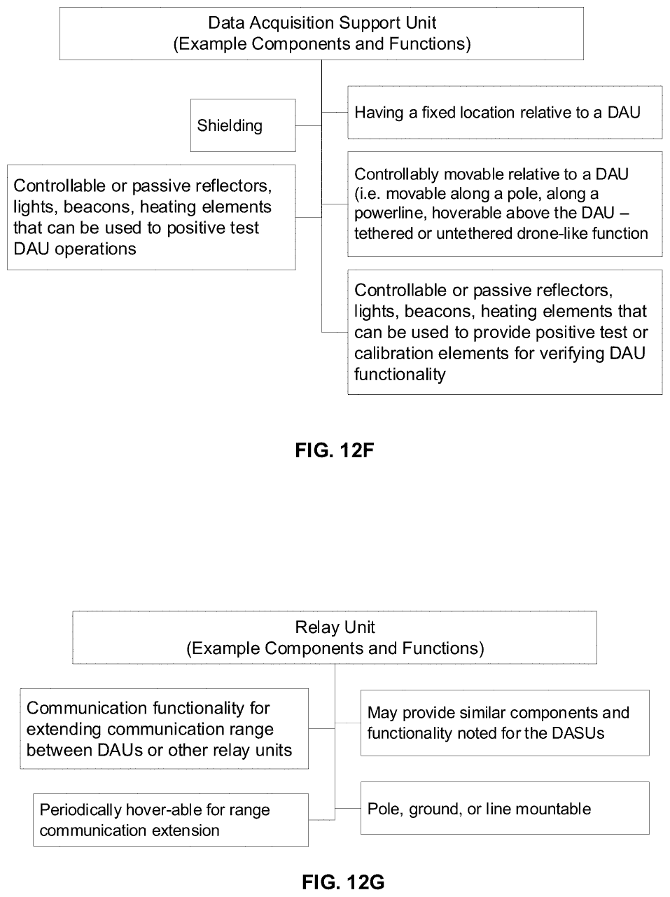

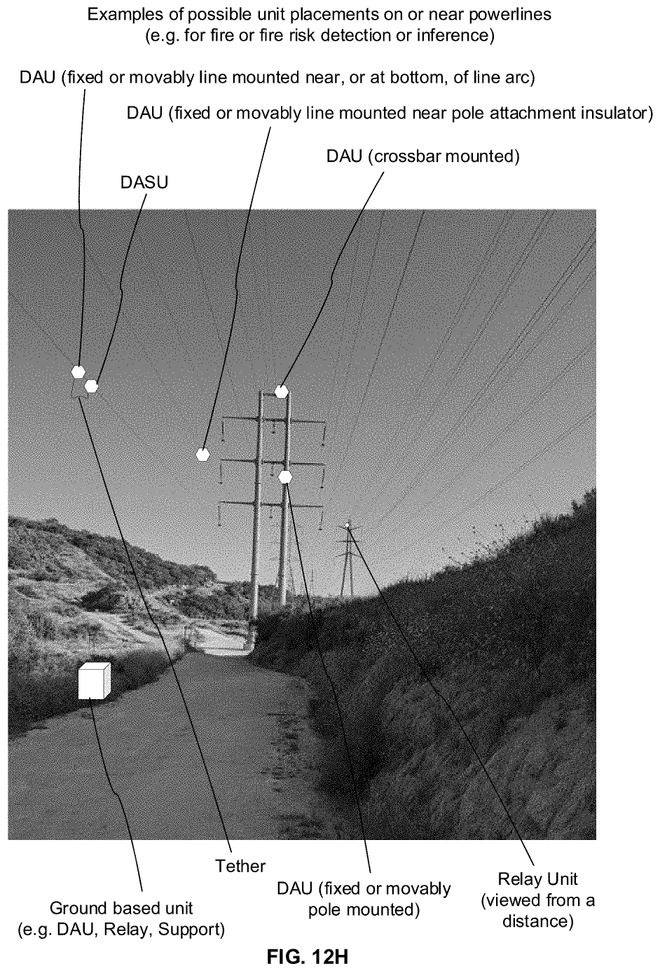

FIG. 12A provides a block diagram with example subsystems, components and configurations that can be implemented in some embodiments of a DAU where any given DAU may make use of only a portion of the indicated systems, components, or configurations.

FIG. 12B provides a block diagram with example power sources that might be used in operating a DAU where any given DAU may make use of only a subset of these components such as one or more batteries and a single power generation source for recharging the one or more batteries while in other embodiments, multiple charging sources may be used.

FIG. 12C provides a block diagram with example transducers or sensors that might be used in a DAU (or other system unit) as sensors, actuators, communication components, and the like, wherein any given unit may include all of, or a subset of, these transducers, multiple implementations of some of these transducers to provide a backup for a particular function or to provide a new or differently implemented function (e.g. ability to provide visual images in two directions simultaneously or an ability to provide visual images from two displaced locations to allow three-dimensional image processing).

The transducers may be used in combination with one another, or even provided in subset packages, to provide enhanced functionality or data processing. In some embodiments, only a small number of transducers or transducer groups (e.g. 1 to 5) may be implemented in any single unit while in other embodiments, a moderate number of transducers or transducer groups may be implemented (e.g. 6-15); while in still other embodiments, a large number of transducers or transducer groups may be implemented (e.g. 16-30), while in still further embodiments, a very large number of these transducers or transducer groups may be implemented (e.g. >=31).

In some embodiments of the present disclosure, visible and/or IR imaging cameras (still or video) are used to provide visual images and/or heat maps. In some embodiments, the cameras may be located on rotatable or translatable mounts so that the cameras may be directed to the targets of interest. In some embodiments, the cameras may be focus-free while in others, they may include autofocus or operator adjustable focus. In some embodiments, both focus-free and adjustable focus cameras may exist on a single DAU while in other embodiments, multiple focus-free and/or focusable cameras may exist. Use of such a plurality of cameras might allow for simultaneous multi-directional viewing (e.g. in opposite directions along a transmission line or along a transmission line and at an angle to the transmission line (e.g. at a 90° angle or at one or both forward or rear facing 45° angles).

In some embodiments, the cameras may be provided with zoom capability that may be operator manipulated. In some embodiments, some cameras may be provided with wide angle or fisheye capability. In some embodiments, a default camera position may be selected to allow simultaneous forward and backward viewing along transmission lines such that any given point along a transmission line and the surrounding environment is viewable from two directions. In some embodiments, such multi-direction viewing may aid in triangulation of events to place events at specific locations and/or to provide verification of event occurrences. In some embodiments IR cameras or visible imaging camera may be mounted on actuatable DAUs such that when an event of interest is found, the DAU may move along a pole or line to get a different view of the event. In some embodiments, cameras may be provided with different forms of image stabilization where an amount of stabilization implemented from image-to-image may be used as data.

In some embodiments, non-imaging, multi-direction IR transducers (e.g. in detector arrays) may be used in place of, or in addition to cameras to provide rough directional or movement information about IR sources (such as flying embers). Such non-imaging detectors may be used to provide guidance information for redirecting cameras to locations of interest while not completely losing perception in other directions. In some embodiments, IR cameras and visible imaging cameras, and non-imaging detectors may include fixed or moveable shields to minimize negative effects of glare. In some embodiments, such detectors may be limited to one or more narrow wavelength bands (e.g. within 2 microns or less) to minimize risk of interference from sunlight and other sources.

In some embodiments, Global Positioning Systems (GPS), compass direction information, gravity direction information, and known environmental information may be used together along with known positions of the sun and the moon to provide supplement information for interrupting sensor readings or even for redirecting sensing directions.

In some embodiments, accelerometers or gyroscopes may be included in DAUs, DASUs, or RUs to allow detection of vibration or movement (swinging or swaying) of mounting locations (e.g. on poles or transmission wires) which might be useful in a variety of ways; including for detecting transmission line or pole movement which might be compared to previous movements and/or to excess movement thresholds which may be useful in providing failure risk assessments and/or failure detection which might in turn be useful in ascertaining or directing deployment of inspection teams, maintenance crews, emergency response teams, or transmission line operational status.

In some embodiments, compass and/or level transducers along with accelerometers, visual or IR image transducers, electromagnetic field transducers, and the like, maybe useful in ascertaining wire or pole movement. Such transducers/sensors may also be used to detect a change to wire angle at a given mounting position and thus be used in ascertaining risk or occurrence of transmission line failure. Such transducers may also be helpful in understanding working directions and vertical orientation of components co-mounted with sensors.

In some embodiments GPS positioning information and compass direction information may be useful in determining DAU mounting locations, change in location due to DAU actuated movement or due to transmission wire or tower movement. Such information may be useful in calculating event locations or relative positions of different DAUs, DASUs, and Rus.

In some embodiments, weather parameter related sensors (e.g. wind speed, wind direction, humidity, and temperature) may provide local information about weather conditions which could be useful in determining whether a heightened risk of fire, excess transmission line movement, or excess tower movement exists.

FIG. 12D provides a block diagram with example control and electronic communication components, wherein in any given DAU, only a subset of these components may be included while in others, all may be included.

FIG. 12E provides a block diagram with example functions that might be implemented by control and electronic communication components, wherein in any given DAU, only a subset of these functions may be included while in others, all may be included.

FIG. 12F provides some example features that may be included in a DASU wherein in any given DASU, only a subset of these features may be included while in others, all may be included.

FIG. 12G provides some example features that may be included in a RU wherein in any given RU, only a subset of these features may be included while in others, all may be included.

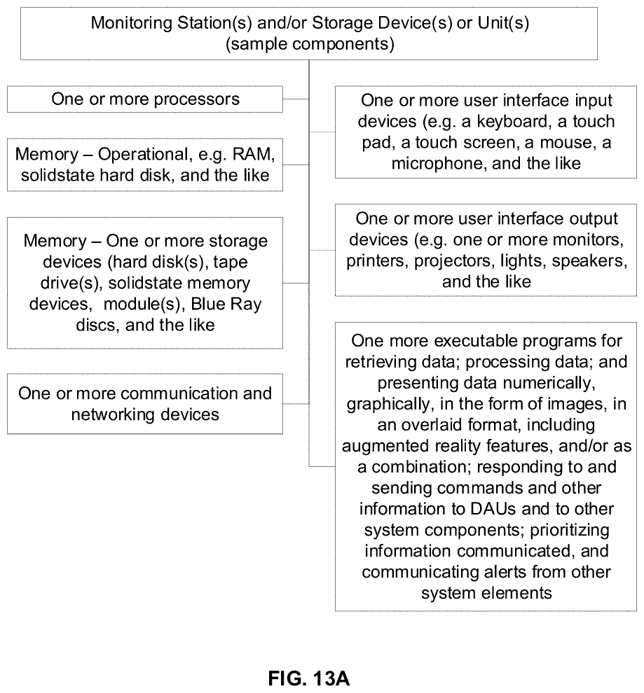

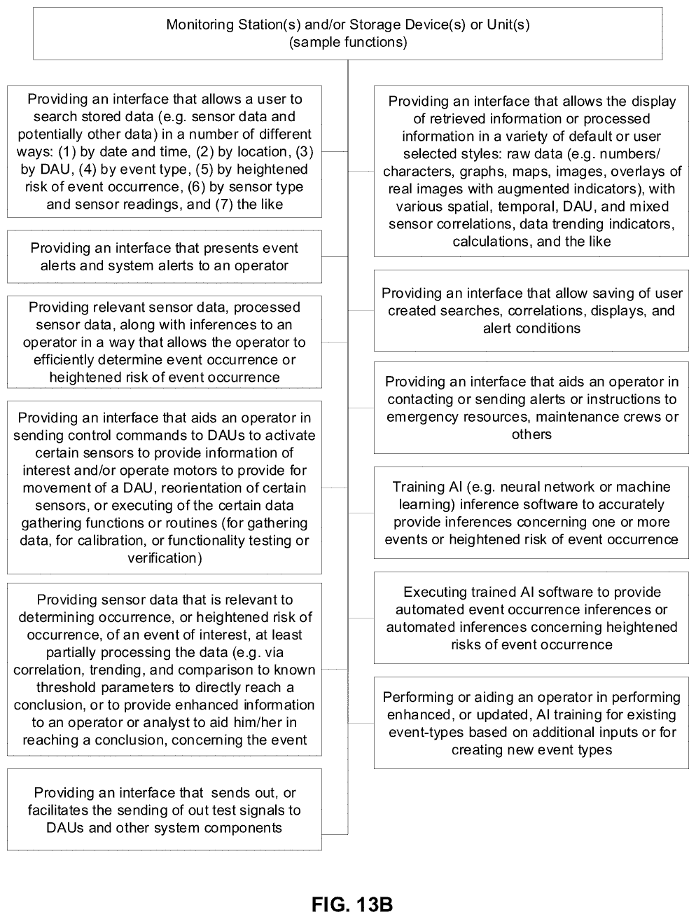

FIG. 13A provides a block diagram setting for various sample components that may be included in a monitoring station or a SD or system.

FIG. 13B provides a block diagram setting for various sample functions that may be performed at a monitoring station or on a SD or system.

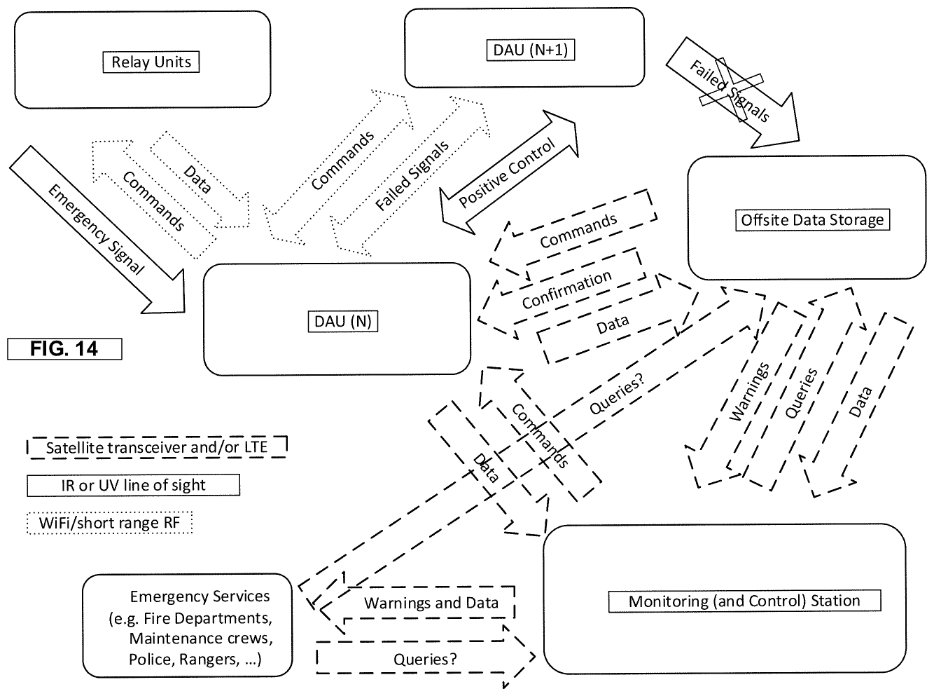

FIG. 14 provides an overview of a communication structure according to a specific embodiment of the present disclosure involving multiple standard DAUs, RUs, an offsite data storage system or server SDs, a command/MSs, and a communication link to emergency services. In the embodiment of FIG. 14, it is anticipated that the DAUs will be capable of sending and receiving signals to the remote sites via terrestrial microwave, RF, or satellite signals. It is also anticipated that the DAUs communicate with each other via line of sight communication using IR or UV signals (e.g. UV might be helpful for penetrating smoke and clouds). DAU to DAU direct communication will only send key information, like an indication of interference, the presence of a critical event without necessarily transmitting the entire body of support data. Line of sight communication may also be used as a control to measure distance and make sure sensors are working.

RUs lack the ability to communicate directly with remote sights/MS and will have fewer sensors. They are cheaper but can serve as additional eyes and controls for the other units. They can bridge gaps when DAUs are too far apart or lack a direct line of sight relationship. Data is sent from standard DAUs to the MS(s), and to remote SDs. Due to the volume of data being transmitted, it may be necessary to limit the standard data retention period to a short period of time (e.g. 24 hours to 1 week) but due to the potential importance of some data, it may be desirable to lock certain data for a greater period of time (e.g. months or even years—such as data associated with fires or other events that occur around transmission lines. The release of a data lock may occur after the lapse of an initially defined period or it may be released earlier upon request of the data owner.

A MS or automatic processing server sends a confirmation signal to a DAU when specific data is received, allowing the unit to stop broadcasting and even to free its own memory of that specific data. If a unit does not receive a confirmation signal, it will attempt to transmit the data at a later time, via a backup network, or via another DAU to which the data was transferred. A MS, or an operator at a MS also sends signals to DAU when a fire is detected by other local DAUs or is reported to the system by other means (e.g. a relevant news source) where the signaling may be used to change the operational mode of the DAUs to test functionality (perform Quality Control checks), free memory space, enhance monitoring, processing, and/or transmit protocols.

As MS receives data from DAUs, it can query data stored on SDs for given DAUs, for given time periods, for given data categories, or sensor categories, as well as in numerous other ways. It can send commands to the DAUs and through those to the RUs or DAUs. It can be used to view all units at once, or to view data from individual units. Received data may include raw data, alerts, warnings, and event critical event signals when data processing occurs on the DAUs. The MS may be responsible for performing some data processing in some embodiment and/or even perform all data processing in other embodiments. The MS can also send data and notifications to local emergency responders (e.g. fire fighters) when an event is detected and, in some embodiment, such emergency responders may be provided with direct access to the data or even provided with at least some control of the DAUs.

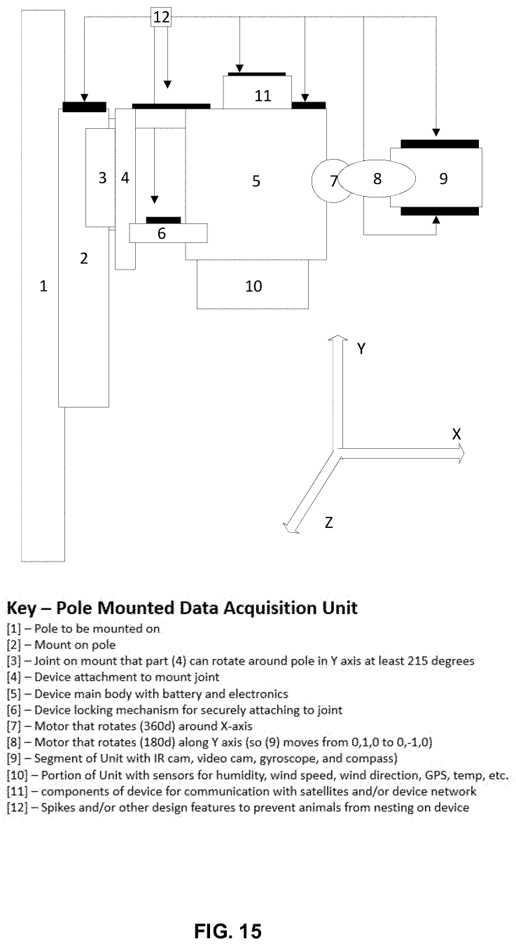

FIG. 15 provides a schematic representation of a DAU according to an embodiment of the present disclosure where the DAU is configured for mounting to a vertical pole. In this configuration, the transducer components, the power components, the communication components, processing components and the electronic components can be interconnected for surveying transmission lines and/or poles/structures.

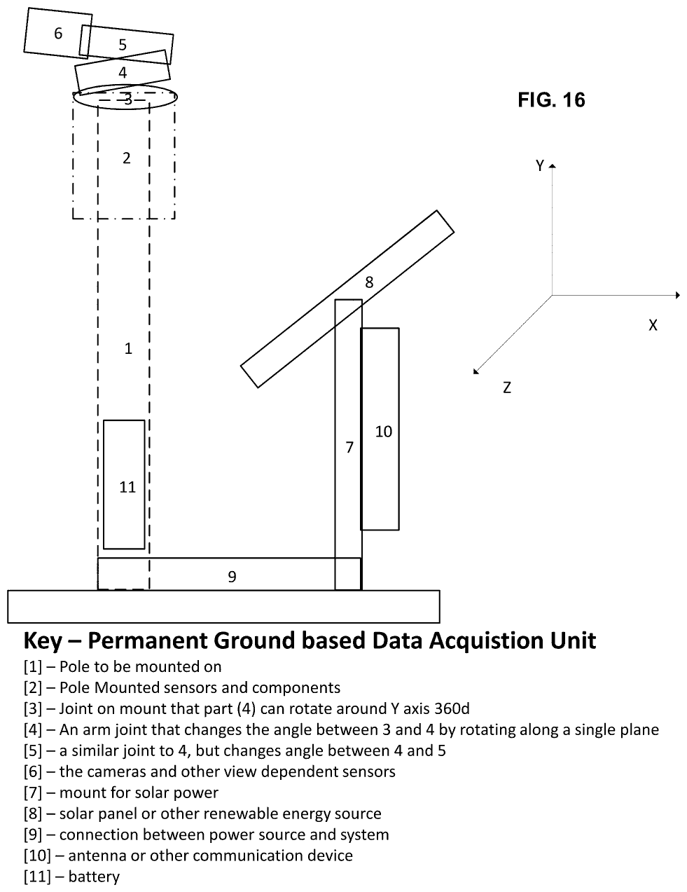

FIG. 16 provides a schematic representation of a DAU according to an embodiment of the present disclosure where the DAU is configured for mounting to ground or to another horizontal surface.

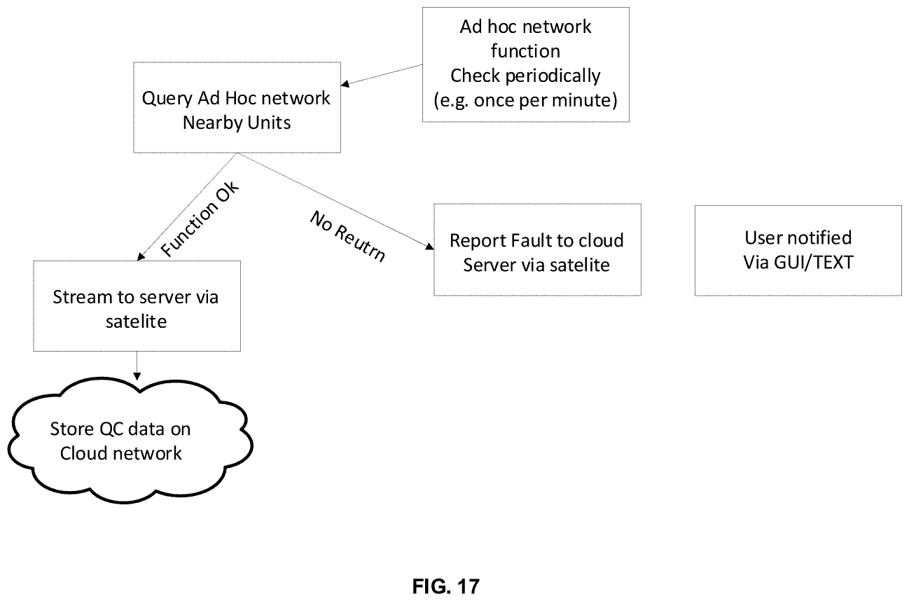

FIG. 17 provides a sample process flow for confirming Ad Hoc network operation and reporting of errors via satellite communication.

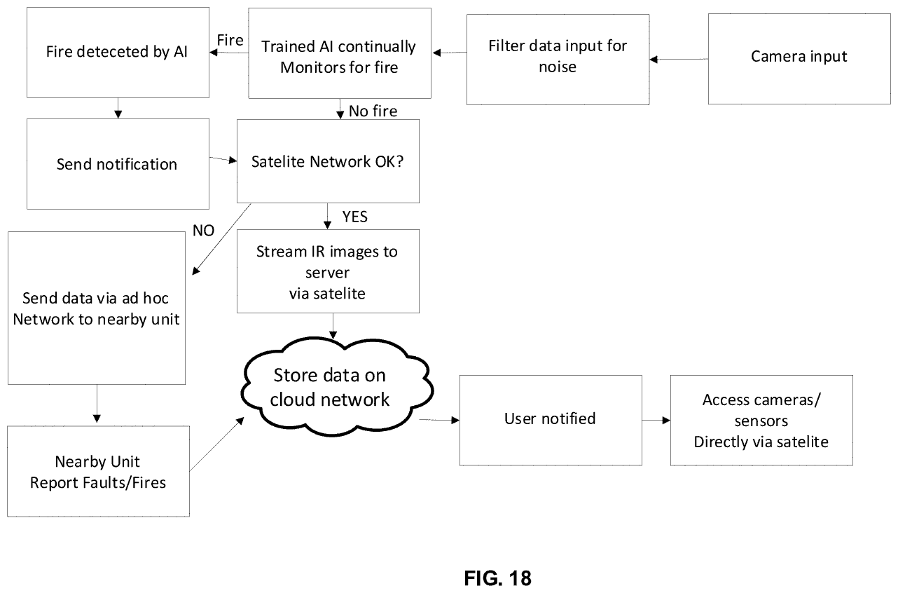

FIG. 18 provides a sample flowchart setting forth sample steps in a process for detecting a fire when using an AI inference system and wherein results of the process are communicated to a user via satellite or an Ad Hoc network and the data is saved. In some embodiments, the data transmission can be reduced to conserve bandwidth especially when the system is implemented to detect anomalies on a localized basis. Thus, a network of localized AI based analysis systems can be used while keeping data rates low. Moreover, in some embodiments a mesh network topology can be implemented to share or propagate data from one DAU to another DAU or one MS to another MS or between multiple DAUs and their associated MSs, such that the data transmission is reduced especially when integrating cellular connection or satellite uplink.

The systems/subsystems and units/components described herein can be implemented on a system or a divided platform incorporating electronic and computational modules that control the operation of the processes of present disclosure and the method steps.

The processing device is a machine such as a computer, and its progeny, designed to carry on all the operations and computational aspects of the system using a processor, a memory a controller, and communications circuitry. The processor can be a Central Processing Unit (CPU), Graphics Processing Unit (GPU), Virtual Processing Unit (VPU), or a series of processors and/or microprocessors, but are not limited in this regard, connected in series or parallel to execute the functions relayed through the memory which may house the software programs and/or sets of instructions.

The processor and memory are interconnected via bus lines or other intermediary connections. The processor and controller are also interconnected via bus lines or other intermediary connections. The controller sends control signals to the other components of the system's electronic and computational modules. The memory can be a conventional memory device such as RAM (Random Access Memory), ROM (Read Only Memory) or other volatile or non-volatile basis that is connected to the processor(s) and to the controller. The memory includes one or more memory devices, each of which includes, or a plurality of which collectively include a computer readable storage medium. The computer readable storage medium may include a read-only memory (ROM), a flash memory, a floppy disk, a hard disk, an optical disc, a flash disk, a flash drive, a tape, a database accessible from a network, and/or any storage medium with the same functionality that can be contemplated by persons of ordinary skill in the art to which this disclosure pertains.

The processing device is connected to various other aspects of the system's electronic and computational modules. For example, the processing device is connected to a communication module which enables it to communicate with remote devices or servers on a wired or on a wireless basis. The communication module in return can communicate with a network such as a cloud or a web, on a need to basis. Thereby, receiving operational instructions and/or image information/data from a source other than what is available to the processor(s) and/or the memory.

The processing device is also connected to a database. The database or its entries can be sent through the communication module to the network.

The processing device is also connected to the input module in order to intake the user's directives. The input module can also be used to select operational mode of the system platform, send and receive data, record audio or video streams, etc.

The processing device can also be connected to a video/graphics processor to process visual information.

The processing device can also be connected to a display which is used to show the system's interface. The display is operated with the use of the video/graphics processor.

The processing device is also connected to a storage which may temporarily or permanently house other executable code, algorithms and programs such as the operating system or the system's platform.

It should be noted that, in some embodiments, the methods may be implemented as a computer program. When the computer program is executed by a computer, an electronic device, or the one or more processors, it carries on the method. The computer program can be stored in a non-transitory computer readable medium such as a ROM, a flash memory, a floppy disk, a hard disk, an optical disc, a flash disk, a flash drive, a tape, a database accessible from a network, or any storage medium with the same functionality that can be contemplated by persons of ordinary skill in the art to which this disclosure pertains.

In addition, it should be noted that in the operations of the following method, no particular sequence is required unless otherwise specified. Moreover, the following operations may also be performed simultaneously, or the execution times thereof may at least partially overlap.

Furthermore, the operations of the following method may be added to, replaced, and/or eliminated as appropriate, in accordance with various embodiments of the present disclosure.

Numerous variations to the above noted illustrated embodiments are possible and will be apparent to those of skill in the art. Some variations may be based on combinations of features or elements from different embodiments for an enhanced system, device, or method, or may be used to form a simplified system, device, or method.

Though various portions of this specification have been provided with headers, it is not intended that the headers be used to limit the application of teachings found in one portion of the specification from applying to other portions of the specification. For example, alternatives acknowledged in association with one embodiment, are intended to apply to all embodiments to the extent that the features of the different embodiments make such applications functional and do not otherwise contradict or remove all benefits of the adopted embodiment. Various other embodiments of the present disclosure exist. Some of these embodiments may be based on a combination of the teachings set forth herein with various teachings incorporated herein by reference.

It is intended that any aspects of the disclosure set forth herein represent independent disclosure descriptions which Applicant contemplates as full and complete disclosure descriptions that Applicant believes may be set forth as independent claims without need of importing additional limitations or elements from other embodiments or aspects set forth herein for interpretation or clarification other than when explicitly set forth in such independent claims once written. It is also understood that any variations of the aspects set forth herein represent individual and separate features that may form separate independent claims, be individually added to independent claims, or added as dependent claims to further define an disclosure being claimed by those respective independent or dependent claims should they be written.

In view of the teachings herein, many further embodiments, alternatives in design and uses of the embodiments of the instant disclosure will be apparent to those of skill in the art. As such, it is not intended that the disclosure be limited to the illustrative embodiments, alternatives, and uses described above but instead that it be solely limited by the claims presented hereafter.

Although the present disclosure has been described in considerable detail with reference to certain embodiments thereof, other embodiments are possible. Therefore, the scope of the appended claims should not be limited to the description of the embodiments contained herein.

What is claimed is:

1. An anomaly detection system, comprising:
at least one data acquisition unit communicatively coupled to at least one monitoring station wherein the data acquisition unit is affixed unto a powerline structure and/or an ancillary pole;
the data acquisition unit incorporates at least one transducer, used to measure environmental conditions and/or characteristics of the surrounding area; and
the data acquired by the data acquisition unit relays the data from the transducer to the at least one monitoring station for identification of an anomaly.

2. The anomaly detection system of claim 1, wherein the at least one transducer incorporates one or more of the following types of sensors:
wind speed sensor, wind direction sensor, air temperature sensor, gravity sensor, accelerometer, rotational motion sensor, barometric pressure sensor, humidity level sensor, surface temperature sensor, compass sensor, Global Positioning System sensor, orientation and/or elevation sensor, conductivity sensor, resistivity and current flow sensors, torsional sensor, image sensor, light sensor, ultraviolet light sensor, infrared light sensor, radio wave sensor, spectral wavelength sensor, sound sensor, optical sensor, vibration and electromagnetic sensors.

3. The anomaly detection system of claim 2, wherein the at least one monitoring station analyzes the data supplied by the at least one data acquisition unit using prior datasets by comparison or through an artificial intelligence algorithm to identify an anomaly such as: fire risk, obstruction, physical failure, abnormal temperature, abnormal movement, line stress or sagging, excessive throughout, abnormal vibrations, abnormal moisture or abnormal humidity.

4. The anomaly detection system of claim 1, further comprising a relay unit communicatively coupled to a primary data acquisition unit and at least one or more secondary data acquisition units.

5. The anomaly detection system of claim 1, further comprising one or more storage device(s) communicatively coupled to the at least one monitoring station or the at least one data acquisition unit.

6. The anomaly detection system of claim 3, wherein the analysis of the data can trigger an alert and/or be further used to retrain the artificial intelligence algorithm.

7. The anomaly detection system of claim 1, further comprising one or more data acquisition support units communicatively coupled to the at least one data acquisition units.

8. The anomaly detection system of claim 3, wherein:
the at least one data acquisition unit has at least two optical or imaging sensors oriented to monitor different perspectives of the powerline structure, its components and/or a transmission wires located on the powerline or on its components; and
the at least two optical or imaging sensors have three degrees of freedom.

9. The anomaly detection system of claim 3, wherein the at least one data acquisition unit and the at least one monitoring station are communicatively coupled together over a mesh network topology such that data transmission between these components are minimized following the analysis conducted using the artificial intelligence algorithm.

10. The anomaly detection system of claim 1, wherein data can be shared amongst any of the at least one data acquisition unit or any of the at least one monitoring station.
